(19) United States
(12) Patent Application Publication
(10) Pub. No.: US 2008/0197008 A1
(43) Pub. Date: Aug. 21, 2008

(54) Electrical Switchgear and Method for Operating an Electrical Switchgear

(75) Inventors: Jurgen Einschenk, Panketal (DE); Jurgen Jager, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 11/994,708

(22) PCT Filed: Jul. 4, 2006
(86) PCT No.: PCT/EP2006/063844

§ 371 Date: Jan. 15, 2008

(30) Foreign Application Priority Data
Jul. 7, 2005 (DE) DE102005032709.5

(51) Int. Cl. H01H 33/66

(52) U.S. Cl. 200/48 R; 218/118

(57) ABSTRACT

An electrical switchgear has a first switching point and a second switching point The first switching point is arranged inside an evacuated region. The second switching point is arranged outside the evacuated region. The first switching point is surrounded by the second switching point. For the connection process of the electrical switchgear, the first switching point is switched on before the second switching point, and for the disconnection process, the first switching point is switched off after the second switching point.

The invention relates to an electrical switching device having a first switching point, which is arranged within an evacuated area, and having a second switching point, which is arranged outside the evacuated area, and to a method for operation of an electrical switching device such as this.

An electrical switching device of the type mentioned above is known, for example, from U.S. Pat. No. 4,538,039. In the known arrangement, a first switching point of the electrical switching device is arranged in an evacuated area. A second switching point of the electrical switching device is arranged outside the evacuated area. The switching points are in the form of so-called vacuum interrupters and compressed-gas-isolated switching points. The two switching points are arranged alongside one another, and are formed independently of one another. This results in an arrangement which requires a comparatively large amount of space.

One object of the invention is therefore to specify an electrical switching device of the type mentioned initially which occupies less space.

The object is achieved in the case of an electrical switching device of the type mentioned initially, according to the invention, in that the first switching point is surrounded by the second switching point.

By avoiding the use of conventional switching points and the physical linking of the first switching point and the second switching point, it is possible to form a compact electrical switching device.

A dielectrically advantageous design for an electrical switching device can also be produced by surrounding the first switching point by the second switching point.

Furthermore, the second switching point may surround the first switching point in such manner that the first switching point is protected against external mechanical influences. There is no need for additional barriers for protection of the evacuated area.

A further object of the invention is to specify a suitable method for operation of switching device according to the invention.

An advantageous method for operation of an electrical switching device having a first switching point, which is arranged within an evacuated area, and having a second switching point, which is arranged outside the evacuated area, in which during a connection process, the first switching point is connected at a time before the second switching point and, during a disconnection process, the first switching point is disconnected at a time after the second switching point, has the advantage that any switching arcs which may occur preferably occur adjacent to the first switching point. The second switching point is protected against increased contact erosion by the first switching point. Appropriate encapsulation can be provided in order to bound the evacuated area. This encapsulation is designed to maintain the vacuum in an appropriately gas-tight form. If switching arcs, for example pre-arcing during connection processes or disconnection arcs, are deliberately kept within the encapsulation, then it is virtually impossible for the arc to emerge from encapsulation. Components arranged adjacent, such as the second switching point, drive apparatuses or other components, are thus well protected against the thermal effects of the arcs. By way of example, this makes it possible to use open switching contacts for the second switching point since the encapsulation prevents the arc from jumping over to the contacts of the second switching point.

In one advantageous refinement, it is also possible for the first switching point and the second switching point to be connected electrically in parallel with one another.

Connection of the two switching points electrically in parallel makes it possible to deliberately initiate commutation of a current to be disconnected onto one of the two switching points. For this purpose, during a disconnection process, it is advantageously possible for the current to be disconnected to be deliberately quenched adjacent to the first switching point. This can be done, for example, by a time offset between the switching times of the two switching points.

A further advantageous refinement makes it possible for the first switching point to have a first and a second switching piece which can move relative to one another and are arranged axially opposite one another, and for the second switching point to have a first and a second switching piece, which can move relative to one another, are rotationally symmetrical and are arranged co-axially with respect to the switching pieces of the first switching point.

The axially opposite switching pieces are moved relative to one another in the axial direction. If the switching pieces of the first and of the second switching point are arranged co-axially in a rotationally symmetrical form, this results in a body with dielectrically advantageous design. Particularly when the electrical switching device is used in the medium-voltage and high-voltage field, it is therefore possible to also cope with increased electrical field strengths. The two switching points should in each case advantageously be cylindrical, and are arranged interleaved in one another.

A further advantageous refinement makes it possible, in one projection, for an interrupter path of the disconnected second switching point to be covered by encapsulation which bounds the evacuated area.

Switching pieces which can move relative to one another are used, and when the respective switching contact is in the disconnected state, an interrupter path is created between the switching pieces involved and is used for potential isolation between the switching pieces. The encapsulation which bounds the evacuated area must be formed at least in places from an electrically insulating material in order to allow the switching pieces of the first switching point to be kept isolated from one another. This avoids shunt paths which could have a negative influence on the switching capability of the switching points. In one projection, for example radially with respect to the axis on which the switching pieces of the first switching point are arranged, and with respect to which, for example, the switching pieces of the second switching point are also arranged co-axially, the encapsulation may cover the isolation point of the second switching point. This makes it possible to inspect the encapsulation through the open second switching point. With a rotationally symmetrical design, this can be done from a large number of positions, thus allowing quick inspection.

Furthermore, it is advantageously possible for the electrical switching device to have an essentially rotationally symmetrical housing with a first housing section and a second housing section which are arranged at a distance from one another, leaving a gap free.

Use to of rotationally symmetrical housing sections assists the dielectric strength of the electrical switching device. The electrical insulation makes it possible to apply different electrical potentials to the two housing sections, as well, without producing short circuits or the like.

It is also advantageous for the gap to be covered by at least one electrically insulated holding element, which connects the first and the second housing section.

Electrically insulated holding elements can be used in order to connect the two housing sections such that the angle between them is stiff.

By way of example, the holding element may be in the form of a plate. A plurality of these holding elements may be arranged distributed on the circumference of the two housing sections. However, it is also possible to manufacture the holding element, for example, from an insulating tube and for this tube to be connected to the housing sections over its entire circumference. This results in a stiff joint between the individual housing sections. If the use of holding elements in the form of plates is preferred, then the encapsulation of the evacuated area can also be inspected through the intermediate spaces between the individual holding elements. In order to ensure this when using a tubular holding element as well, this holding element may, for example, be manufactured from a material through which light can pass.

A further advantageous refinement provides for the gap to an annular gap.

The annular shape avoids sharp edges. The housing sections are formed in a dielectrically advantageous manner. Furthermore, the gap can be used in order, for example, to hold a switching piece of a switching point.

A further advantageous refinement makes it possible for the gap to be electrically bridged by means of a movable switching piece of the second switching point.

The use of the gap as an interrupter path for an electrical switching point makes it possible to make better use of the available physical space adjacent to the electrical switching device.

One advantageous refinement also makes it possible for the evacuated area to be surrounded by an electrically insulating fluid.

By way of example, an electrically insulating fluid may be an electrically negative gas, such as sulfur hexafluoride, nitrogen or mixtures of such gases. However, it is also possible to use a suitable insulating oil to surround the evacuated area. In one simple case, the electric insulating fluid may, for example, be atmospheric air. The use of fluids to which an increased pressure is applied makes it possible to design the electrical switching device to be compact. This makes it possible to reduce the gap or else the separations between the individual switching points, since the breakdown strength is increased by compression of the electrically insulating fluid.

Furthermore, it is advantageously possible for the housing sections to be part of a current path which can be interrupted by means of the electrical switching device.

A suitable electrically insulating holder allows the housing sections to be part of a current path which can be switched by the switching device. The housing sections have an appropriate wall thickness in order to ensure adequate mechanical strength. Use of suitable electrically conductive materials, such as aluminum or copper, allows an electric current to be carried with low losses via the housing sections as well.

A further advantageous refinement makes it possible for the annular gap to surround the evacuated area.

By arrangement of the annular gap in the region of the evacuated area results in the electrical switching device having a shell-like structure. This results in a switching device which is shorter in axial direction and in which there is no offset between the individual switching points.

A further refinement makes it possible for at least one of the housing sections to surround a transmission device which drives the movable switching pieces of the switching points.

By way of example, a transmission device may be used to distribute a drive movement between the movable switching pieces and to force there to be a time offset between the movements of the switching pieces of the two switching points. The arrangement within at least one housing section allows the transmission device to be protected by the housing sections themselves against mechanical forces acting on them. Furthermore, the housing sections can hold the transmission device within an area in which there is no field. This prevents the formation of parallel current paths on the transmission device as a result of which, for example, smaller discharges could also occur.

The invention will be described in more detail in the following text and illustrated schematically in a drawing on the basis of one exemplary embodiment.

In the figures:

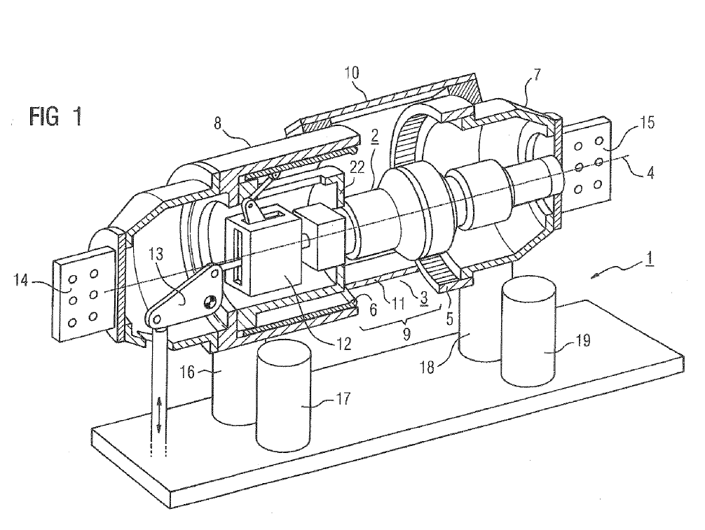

FIG. 1 shows a section through an electrical switching device in a disconnected position,

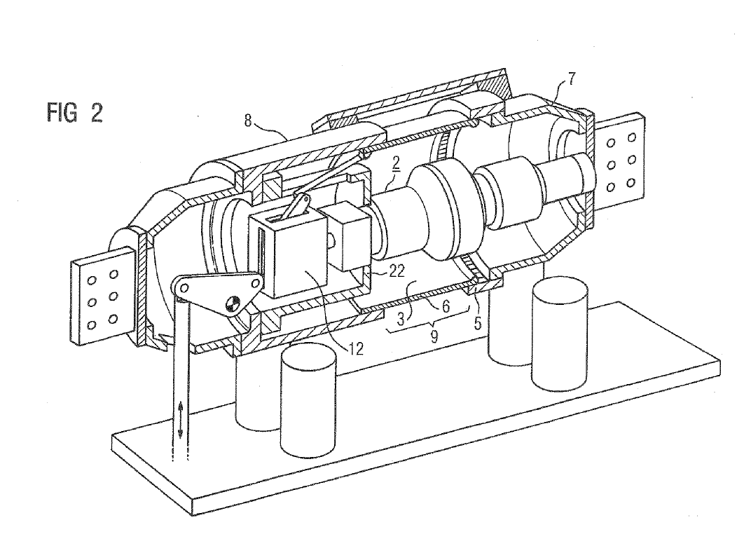

FIG. 2 shows a section through the electrical switching device in a connected position, and

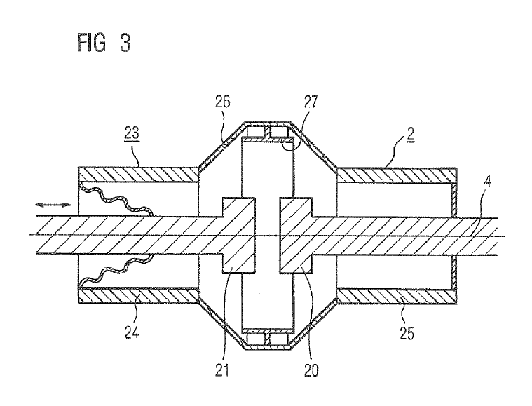

FIG. 3 shows a section through encapsulation of a first switching point.

The design of an electrical switching device according to the invention will be described in the following text with reference to FIG. 1. FIG. 1 shows an electrical switching device 1. The electrical switching device 1 has a first switching point 2 and a second switching point 3. The first switching point 2 is in the form of a vacuum interrupter and has an evacuated area in its interior. FIG. 3 illustrates the design of the first switching point 2, which will be described in more detail in the associated description section.

The first switching point 2 has a rotationally symmetrical design and is arranged co-axially with respect to a first axis 4,along this axis 4. The second switching point 3 surrounds the first switching point 2. The second switching point 3 is rotationally symmetrical and is arranged co-axially with respect to the first axis 4. The second switching point 3 has a first switching piece 5 and a second switching piece 6. The second switching piece 6 can be moved by means of a drive along the first axis 4. The first switching piece 5 of the second switching point 3 is mounted in a fixed position. The switching pieces 5, 6 of the second switching point 3 are hollow-cylindrical and are each arranged co-axially with respect to the first axis 4. On the inside, the first switching piece 5 has a multiplicity of moving contact elements. The second switching piece 6 can be moved with an outer casing area into these moving contact elements so that electrical contact can be made between the first switching piece 5 and the second switching piece 6 of the second switching point 3.

The first switching piece 5 is mounted on a first housing section 7. The second switching piece 6 is mounted on a second housing section 8. The housing sections 7, 8 are each essentially rotationally symmetrical and are arranged co-axially with respect to the first axis 4. An annular gap 9 is formed between the axially opposite ends of the two housing sections 7, 8. The annular gap 9 is used as interrupter path for the second switching point 3. For robustness, the two housing sections 7, 8 are connected to one another by means of a plurality of electrically insulating holding elements 10, 11. The holding elements 10, 11 are arranged distributed uniformly around the circumference of the two housing sections 7, 8. In a projection at right angles to the first axis 4, the annular gap 9 when the second switching point 3 is in the open state is covered by encapsulation 23 which bounds the evacuated area of the first switching point 2. The zones which are left free between the individual holding elements 10, 11 make it possible to look in through the outer wall of the encapsulation 23 at the first switching point 2. The two switching points 2, 3 are connected electrically in parallel with one another.

A transmission device 12 is arranged within the second housing section 8. The transmission device 12 has a drive lever 13 for transmitting a drive movement, via which a connection or disconnection movement is initiated. On the output drive side, output drive levers are provided for the movable switching pieces 6, 21 of the first and second switching points 2, 3. In this case, the transmission device 12 is designed to produce a time offset between the start and the end of the movement of the movable switching pieces 6, 21. For example, during a connection process, it is possible for the moveable switching piece 21 of the first switching point 2 to be moved first of all, followed by the moveable second switching piece 6 of the second switching point 3. A corresponding situation can be provided for a disconnection process, with the movable second switching piece 6 of the second switching point 3 being moved first of all, and with the movable switching piece 21 of the first switching point 2 being moved at a later time.

Connecting pieces 14, 15 are arranged at the mutually remote ends of the rotationally symmetrical housing sections 7, 8 and are used for connection of an electrical supply line. Via the connecting pieces 14, 15, the housing sections 7, 8 can be used as part of a current path to be switched within an electrical power transmission system. The first switching piece 5 of the second switching point 3 is electrically conductively connected to the first housing section 7 via a rigid joint. The second switching piece 6 of the second switching point 3 is electrically conductively connected to the second housing section 8 via a corresponding sliding contact arrangement. The second switching piece 6 of the second switching point 3 can be moved telescopically with respect to this within a cylindrical section of the second housing section 8. By way of example, sprung contact fingers, helical springs or the like can be arranged as contact elements in the boundary layer between the second switching piece 6 of the second switching point 3 and the cylindrical section of the second housing section 8.

Supporting insulators 16, 17, 18, 19 in the form of pillars are used to hold the electrical switching device 1 such that it is isolated. The electrical switching device 1 may be surrounded by an electrically insulating fluid, for example an insulating liquid or an insulating gas. By way of example, this may also be done at a pressure that is higher than that of the rest of the surrounding area. The insulating medium can also flow into the interior of the electrical switching device through appropriate openings, and can surround the first switching point 2 there.

FIG. 2 shows the location of the second switching piece 6 of the first switching point 2 when it is in its connected position. The annular gap 9 is now bridged by the hollow-cylindrical second switching piece 6. The two housing sections 7, 8 make electrical contact with one another. The housing sections 7, 8 are now part of a connected current path. In the same way as the galvanic contact between the first and the second switching piece 5, 6 of the second switching point 3, a galvanic connection is also made between the switching pieces there in the interior of the encapsulation 23 of the first switching point 2. As a result of the successive switching operations of the first and second switching points 2, 3 in time as described above, the first switching point 2 acts as a power switching point, and the second switching point 3 acts as an isolation point, since this is generally switched with no current flowing.

The design of the first switching point 2 will be explained in more detail in the following text with reference to the section illustrated in FIG. 3. The first switching point 2 has a first switching piece 20 and a second switching piece 21. The first switching piece 20 is mounted in a fixed position. The second switching piece 21 is mounted such that it can move, and can be driven via the transmission device 12. The switching pieces 20, 21 of the first switching point 2 are arranged axially opposite and can move relative to one another along the first axis 4. The first switching piece 20 of the first switching point 2 is electrically conductively connected to the first switching piece 5 of the second switching point 3 via its mounting on the first housing section 7. Furthermore, the second switching piece 21 of the first switching point 2 is electrically conductively connected to the second switching piece 6 of the second switching point 3 via a mounting body 22 (see FIGS. 1, 2) and the second housing section 8. The first switching pieces 5, 20 and the second switching pieces 6, 21 are therefore each of the same electrical potential.

The switching pieces 20, 21 of the first switching point 2 are surrounded by encapsulation 23. In its interior, the encapsulation 23 has an evacuated area. This evacuated area is also referred to as a vacuum. The encapsulation 23 has a first and a second tubular insulating piece 24, 25, with the tubular insulating pieces 24, 25 being arranged co-axially with respect to the first axis 4. The tubular insulating pieces 23, 24 are connected to one another by means of a metallic central body 26 at their mutually facing ends. The interrupter path of the first switching point 2 is arranged in the region of the central body 26. In order to hold erosion products, an electrode 27 is arranged in the interior of the encapsulation 23 in the region of the central body 26. The switching pieces 20, 21 of the first switching point 2 are passed through a wall section, in a gas-tight form, at the mutually remote ends of the tubular insulating pieces 24, 25. The encapsulation 23 may be surrounded by a mechanical-shock-absorbent casing as protection against mechanical shock.

1-13. (canceled)

14. An electrical switching device, comprising:
a first switching point disposed in an evacuated chamber;
a second switching point disposed outside said evacuated chamber and surrounding said first switching point.

15. The electrical switching device according to claim 14, wherein said first switching point and said second switching point are electrically connected in parallel with one another.

16. The electrical switching device according to claim 14, wherein:
said first switching point includes first and second switching pieces movably disposed relative to one another and disposed axially opposite one another;
said second switching point includes first and second switching pieces movably disposed relative to one another, formed rotationally symmetrical, and disposed coaxially with respect to said first and second switching pieces of said first switching point.

17. The electrical switching device according to claim 14, which comprises an encapsulation bounding said evacuated chamber and covering an interrupter path of a disconnected said second switching point in one projection.

18. The electrical switching device according to claim 14, which comprises a substantially rotationally symmetrical housing formed with a first housing section and a second housing section disposed at a distance from one another and leaving a gap therebetween.

19. The electrical switching device according to claim 18, which comprises at least one electrically insulated holding element covering said gap and connecting said first and second housing sections.

20. The electrical switching device according to claim 18, wherein said gap is an annular gap.

21. The electrical switching device according to claim 18, wherein a movable said switching piece of said second switching point is formed to electrically bridge said gap.

22. The electrical switching device according to claim 14, which comprises an electrically insulating fluid surrounding said evacuated chamber.

23. The electrical switching device according to claim 18, wherein said first and second housing sections form part of a current path to be interrupted by way of the electrical switching device.

24. The electrical switching device according to claim 20, wherein said annular gap surrounds said evacuated chamber.

25. The electrical switching device according to claim 24, which comprises an electrically insulating fluid surrounding said evacuated chamber.

26. The electrical switching device according to claim 18, which further comprises a transmission device for driving said movable switching pieces of said switching points, and wherein at least one of said first and second housing sections surrounds said transmission device.

27. A method of operating an electrical switching device having a first switching point disposed within an evacuated chamber and second switching point disposed outside the evacuated chamber, the method which comprises:
during a connection process, contacting the first switching point prior to contacting the second switching point; and
during a disconnection process, disconnecting the first switching point at a point in time after disconnecting the second switching point.
